(19) United States
(12) Patent Application Publication
(10) Pub. No.: US 2024/0394092 A1
(43) Pub. Date: Nov. 28, 2024

(54) MEMORY SNAPSHOT MANAGEMENT METHOD AND APPARATUS, AND DEVICE AND MEDIUM

(71) Applicant: INSPUR SUZHOU INTELLIGENT TECHNOLOGY CO., LTD., Suzhou, Jiangsu (CN)

(72) Inventors: Liang WANG, Suzhou, Jiangsu (CN); Shengli ZHOU, Suzhou, Jiangsu (CN); Zhen FENG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/697,242

(22) PCT Filed: Nov. 30, 2022
(86) PCT No.: PCT/CN2022/135512

§ 371 Date: Mar. 29, 2024

(30) Foreign Application Priority Data
Feb. 9, 2022 (CN) 202210119840.4

(51) Int. Cl. G06F 9/455; G06F 11/14

(52) U.S. Cl. CPC G06F 9/45558; G06F 11/1451; G06F 2009/45575; G06F 2009/45583

(57) ABSTRACT

Provided in the present disclosure are a memory and apparatus for managing a memory snapshot, a device, and a medium. The method includes: when a memory snapshot generation command is acquired, a virtual machine is suspended; a two-level page table of the virtual machine is copied to obtain a first snapshot page table, and a read-only identifier is set for each of page table entries of the two-level page table; and memory pages corresponding to page table entries of the first snapshot page table are acquired by means of the page table entries of the first snapshot page table, a reference count of each of the memory pages is increased, and the virtual machine is restored from a suspended state to a running state.

### CROSS-REFERENCE TO RELATED DISCLOSURE

This present application is a National Stage Application of PCT International Application No. PCT/CN2022/135512 filed Nov. 30, 2022, which claims the benefit of priority to Chinese Patent Disclosure No. 202210119840.4, filed to the China National Intellectual Property Administration on Feb. 9, 2022 and entitled “Memory and Apparatus for Managing Memory Snapshot, Device, and Medium”, which is incorporated herein by reference in its entirety. To the extent appropriate, a claim of priority is made to each of the above disclosed applications.

### TECHNICAL FIELD

The present disclosure relates to the technical field of data protection in a cloud computing environment, and in particular, to a memory and apparatus for managing a memory snapshot, a device, and a medium.

### BACKGROUND

In the related art, in a commonly used virtual machine memory snapshot solution, a virtual machine monitor needs to first suspend a virtual machine, and then export current memory data of the virtual machine to a disk. However, the inventor has realized that as memory data needs to be written to a disk, the process of performing a memory snapshot operation on a virtual machine is very slow, affecting the use of the memory snapshot in real-world scenarios.

### SUMMARY

Some embodiments of the present disclosure provide a method for managing a memory snapshot, including:
in response to acquiring a memory snapshot generation command, a virtual machine is suspended;
a two-level page table of the virtual machine is copied to obtain a first snapshot page table, and a read-only identifier is set for each of page table entries of the two-level page table;
memory pages corresponding to page table entries of the first snapshot page table are acquired by means of the page table entries of the first snapshot page table, a reference count of each of the memory pages is increased, and the virtual machine is restored from a suspended state to a running state.

In some of the embodiments, after the virtual machine is restored from the suspended state to the running state, the method further includes:
in a running process of the virtual machine, in response to detecting that memory data in one memory page of the virtual machine is changed, a memory write operation is performed.

In some of the embodiments, in the process of performing the memory write operation, the method further includes:
the virtual machine is exited from a virtual state, and the page table entries of the two-level page table are queried, by means of a virtual machine monitor program, to obtain a query result;
in response to the query result indicating that one page table entry carries the read-only identifier, a current memory page is copied to obtain a copied memory page, and the reference count of the memory page before the memory data is changed is decreased; and
a pointer of the page table entry in the two-level page table is pointed to the copied memory page, the read-only identifier of the page table entry in the two-level page table is cleared, and the virtual machine is re-entered into the virtual state.

In some of the embodiments, the method for managing the memory snapshot further includes:
in response to acquiring a memory snapshot restoration command, the first snapshot page table is copied to obtain a second snapshot page table; and
a current two-level page table of the virtual machine is deleted, the second snapshot page table is taken as a new current two-level page table of the virtual machine, and page cache corresponding to the first snapshot page table is cleared.

In some of the embodiments, before deleting the current two-level page table of the virtual machine, the method further includes:
the memory pages corresponding to the page table entries of the first snapshot page table are acquired by means of the page table entries of the first snapshot page table, and the reference count of each of the memory pages is increased; and
memory pages corresponding to page table entries of the current two-level page table are acquired by means of the page table entries of the current two-level page table, and a reference count of each of the memory pages is decreased, and the memory pages corresponding to the page table entries of the first snapshot page table is the same as the memory pages corresponding to the page table entries of the current two-level page table.

In some of the embodiments, the method for managing the memory snapshot further includes:
in response to acquiring a memory snapshot deletion command, the corresponding memory pages corresponding to the page table entries of the first snapshot page table are acquired by means of the page table entries of the first snapshot page table, and the reference count of each of the memory pages is decreased; and
the first snapshot page table is deleted.

A second aspect of the present disclosure provides an apparatus for managing a memory snapshot, including:
a command acquisition module, configured to in response to acquiring a memory snapshot generation command, suspend a virtual machine;
a page table copying module, configured to copy a two-level page table of the virtual machine to obtain a first snapshot page table, and set a read-only identifier for each of page table entries of the two-level page table; and
a reference count adjustment module, configured to acquire memory pages corresponding to page table entries of the first snapshot page table by means of the page table entries of the first snapshot page table, increase a reference count of each of the memory pages, and restore the virtual machine from a suspended state to a running state.

In some of the embodiments, the apparatus for managing the memory snapshot further includes:
a page table copying component, configured to under the condition that a memory snapshot restoration command is acquired, copy the first snapshot page table to obtain a second snapshot page table; and
a page table deleting component, configured to delete a current two-level page table of the virtual machine, take the second snapshot page table as a new current two-level page table of the virtual machine, and clear page cache corresponding to the current two-level page table.

A third aspect of the present disclosure provides an electronic device, including:
one or more memories, configured to store computer readable instructions; and
one or more processors, configured to execute the computer readable instructions to implement steps of the method for managing the memory snapshot disclosed in the foregoing.

A fourth aspect of the present disclosure provides a non-volatile computer readable storage medium, configured to store computer readable instructions, and the computer readable instructions, when being executed by a processor, implements the steps of the method for managing the memory snapshot disclosed in the foregoing.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely embodiments of the present disclosure, and a person skilled in the art may still derive other drawings from the accompanying drawings without inventive efforts.

FIG. 1 is a flowchart of a method for managing a memory snapshot according to one or more embodiments of the present disclosure;

FIG. 2 is a sub-flowchart of a method for managing a memory snapshot according to one or more embodiments of the present disclosure;

FIG. 3 is a sub-flowchart of a method for managing a memory snapshot according to one or more embodiments of the present disclosure;

FIG. 4 is a structural schematic diagram of an apparatus for managing a memory snapshot according to one or more embodiments of the present disclosure;

FIG. 5 is a structural diagram of an electronic device according to one or more embodiments of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person skilled in the art based on the embodiments of the present disclosure without inventive efforts shall belong to the scope of protection of the present disclosure.

Currently, in a commonly used virtual machine memory snapshot solution, a virtual machine monitor needs to first suspend a virtual machine, and then export the current memory data of the virtual machine to a disk; and as the memory data needs to be written into the disk, the process of performing a memory snapshot operation on the virtual machine is very slow, affecting the use of the memory snapshot in real-world scenarios. To this end, the embodiments of the present disclosure disclose a memory and apparatus for managing memory snapshot, a device, and a medium, which may avoid the impact of writing memory data into a disk on actual operations, and improve the speed of creating a memory snapshot.

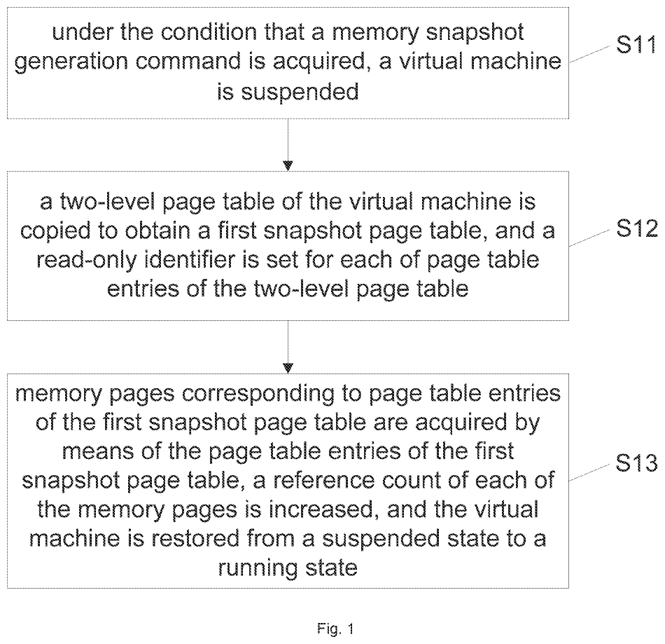

As shown in FIG. 1, an embodiment of the present disclosure discloses a method for managing a memory snapshot, the method including:

step S11: under the condition that a memory snapshot generation command is acquired, a virtual machine is suspended.

In this embodiment, when the memory snapshot generation command sent by a system administrator is acquired, the virtual machine currently in a running state needs to be suspended.

Step S12: a two-level page table of the virtual machine is copied to obtain a first snapshot page table, and a read-only identifier is set for each of page table entries of the two-level page table.

In this embodiment, the two-level page table of the virtual machine is copied at a level of a KVM (i.e. Kernel-based Virtual Machine) to obtain the first snapshot page table, thereby completing creation of a memory snapshot of the virtual machine. It may be understood that, in this embodiment, after the virtual machine is suspended, not all memory data is copied any more, but only the two-level page table of the virtual machine is copied, so as to complete the creation of the memory snapshot. In this embodiment, the first snapshot page table is recorded as a PT1, and the PT1 is used as a snapshot index. In addition, the read-only identifier also needs to be set at the level of the KVM for each of the page table entries in the original two-level page table of the virtual machine, that is, all of the page table entries in the original two-level page table are set to be in a snapshot read-only mode: the setting of the read-only identifier allows for differentiation from the general read-only, thereby implementing differentiation and isolation between the memory snapshot and the virtual machine memory; and the two-level page table is recorded as a PT0. It needs to be pointed out that the created page table is still stored in the memory, so that an IO (input/output) operation of writing the memory snapshot into the disk is avoided, and the process of copying the page table is very fast. Therefore, by this method, the speed of creating a memory snapshot is improved, and it is ensured that the creation of the memory snapshot is completed within a time limit of milliseconds.

Step S13: memory pages corresponding to page table entries of the first snapshot page table are acquired by means of the page table entries of the first snapshot page table, a reference count of each of the memory pages is increased, and the virtual machine is restored from a suspended state to a running state.

In this embodiment, all memory pages to which page table entries points are found by the page table entries of the first snapshot page table, that is, page table entries of the PT1, and the reference counts of these memory pages are increased. It needs to be pointed out that memory leaks may be prevented by adjusting the reference counts; each time a reference to the same object is increased, the reference count of the reference object is increased by one; each time a reference to the same object is deleted, the reference count of the reference object is decreased by one; and when the reference count of an object is decreased to zero, a heap memory to which the object points is automatically deleted. In this embodiment, after the reference count is increased, page cache corresponding to the first snapshot page table needs to be cleared, and then the virtual machine is restored from a suspended state to a running state.

In this embodiment, after restoring the virtual machine from the suspended state to the running state, the method further includes: in a running process of the virtual machine, under the condition of detecting that memory data in one memory page of the virtual machine is changed, a memory write operation is performed. It may be understood that, in the running process of the virtual machine, under the condition that memory data in one memory page of the virtual machine is unchanged, a memory write operation does not need to be performed.

In a process of performing a memory write operation, the method further includes: the virtual machine is exited from a virtual state, and the page table entries of the two-level page table are queried, by means of a virtual machine monitor program, to obtain a query result; under the condition that the query result indicates that one page table entry carries the read-only identifier, a current memory page is copied to obtain a copied memory page, and the reference count of the memory page before the memory data is changed is decreased; and a pointer of the page table entry in the two-level page table is pointed to the copied memory page, the read-only identifier of the page table entry in the two-level page table is cleared, and the virtual machine is re-entered into the virtual state. It should be noted that, as read-only identifiers are previously set for the page table entries of the two-level page table, that is, the current page table entries are in a snapshot read-only mode, it means that write protection is currently performed on the virtual machine memory, and when the virtual machine performs a memory write operation, an EPT misconfig is generated, that is, a memory configuration exception is caused. In this case, the virtual machine needs to exit from a virtual state to a virtual machine monitor program, to enter a memory configuration exception handling process by means of a virtual machine monitor. Firstly a page table entry with a memory configuration exception in a two-level page table (i.e. PT0) is queried, and if the page table entry carries a read-only identifier, page copying is performed to obtain a copied memory page, and the reference count of a original memory page is decreased, then a pointer in the page table entry of the PT0 is pointed to the copied memory page, and finally the snapshot read-only mode in the page table entry of the PT0 is cleared, and normal running of the virtual machine is restored by means of the virtual machine monitor program, that is, the virtual machine is re-entered into a virtual state. By means of the described method, it may be achieved that memory data of a memory page to which the first snapshot page table (i.e. the PT1) points will remain unchanged, and therefore all memory data at a snapshot moment may be found depending on the PT1.

It may be determined that, in the embodiments of the present disclosure, when the memory snapshot generation command is acquired, the virtual machine is suspended; then the two-level page table of the virtual machine is copied to obtain the first snapshot page table, and the read-only identifier is set for each of page table entries of the two-level page table; and then the memory pages corresponding to the page table entries of the first snapshot page table is acquired by means of the page table entries of the first snapshot page table, the reference count of each of the memory pages is increased, and the virtual machine is restored from a suspended state to the running state. It may be determined therefrom that, in the present disclosure, after the memory snapshot generation command is acquired, the virtual machine needs to be suspended, the first snapshot page table is obtained by copying the two-level page table of the virtual machine so as to create a memory snapshot of the virtual machine, the read-only identifier is set for each of the page table entries of the two-level page table, and after the creation step is completed, the virtual machine is restored from the suspended state to the running state. The memory snapshot created by means of the described steps is still stored in the memory, and does not need to be written into a disk any more, thereby avoiding the impact of writing memory data into the disk on actual operations, and improving the speed of creating a memory snapshot. In addition, by setting the read-only identifier for the two-level page table of the virtual machine, differentiation between the memory snapshot and the virtual machine memory is implemented.

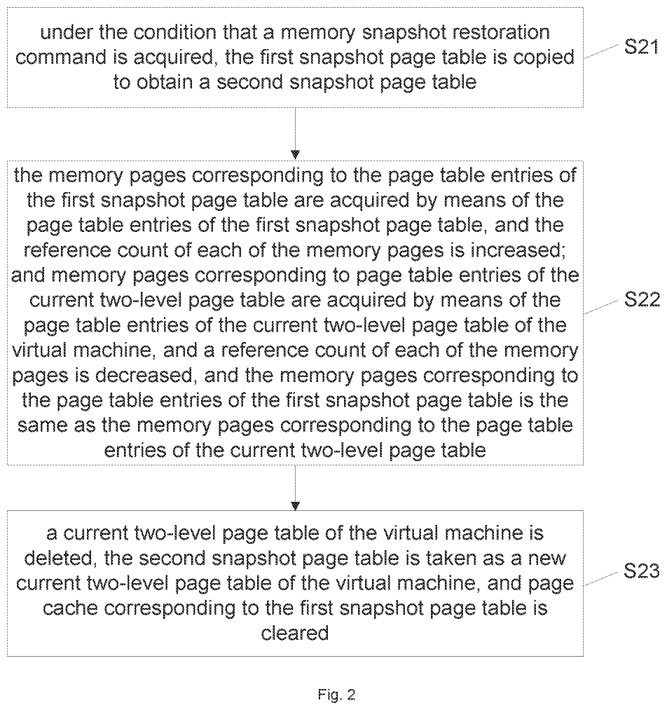

In a running process of the virtual machine, if a memory snapshot restoration command sent by a system administrator is received, that is, the first snapshot page table PT1 needs to be restored, a page table restoration operation corresponding to the memory snapshot restoration command needs to be performed. Specifically, as shown in FIG. 2, the embodiment of the present disclosure may further include:
step S21: under the condition that a memory snapshot restoration command is acquired, the first snapshot page table is copied to obtain a second snapshot page table.

In this embodiment, after a memory snapshot restoration command sent by a system administrator is obtained, the first snapshot page table PT1 is copied at a level of a KVM to obtain a second snapshot page table.

Step S22: the memory pages corresponding to the page table entries of the first snapshot page table are acquired by means of the page table entries of the first snapshot page table, and the reference count of each of the memory pages is increased; and memory pages corresponding to page table entries of the current two-level page table are acquired by means of the page table entries of the current two-level page table of the virtual machine, and a reference count of each of the memory pages is decreased, and the memory pages corresponding to the page table entries of the first snapshot page table is the same as the memory pages corresponding to the page table entries of the current two-level page table.

In this embodiment, the current two-level page table of the virtual machine is recorded as a PT_temp; all of the memory pages corresponding to the current two-level page table are found by the page table entries of the PT1, and the reference counts of these memory pages are increased; and all of the memory pages corresponding to the current two-level page table are found by page table entries of the PT_temp, and the reference counts of these memory pages are decreased. The memory pages corresponding to the page table entries of the PT1 are the same as the memory pages corresponding to the page table entries of the PT_temp.

Step S23: a current two-level page table of the virtual machine is deleted, the second snapshot page table is taken as a new current two-level page table of the virtual machine, and page cache corresponding to the first snapshot page table is cleared.

In this embodiment, the PT_temp page table of the virtual machine is deleted, the second snapshot page table is taken as the new current two-level page table of the virtual machine, and the corresponding page table cache (Translation Look side Buffers) is cleared.

It may be determined that, in the embodiments of the present disclosure, when the memory snapshot restoration command is acquired, that is, when the memory snapshot restoration needs to be performed, the reference count of each of the memory pages is decreased by means of the current two-level page table of the virtual machine, the second snapshot page table obtained by copying the first snapshot page table is used as the new current two-level page table of the virtual machine, then the reference count of each of the memory pages is increased, the original current two-level page table is deleted, and finally the corresponding page table cache is cleared, so as to implement the restoration of the memory snapshot. The snapshot page table is created by copying a page table, so that the speed of restoring a memory snapshot is also improved, and the time for restoring a memory snapshot is the same as the time for creating a memory snapshot, both being limited to the level of milliseconds. In addition, the availability of a memory snapshot is improved by means of the described technical solution.

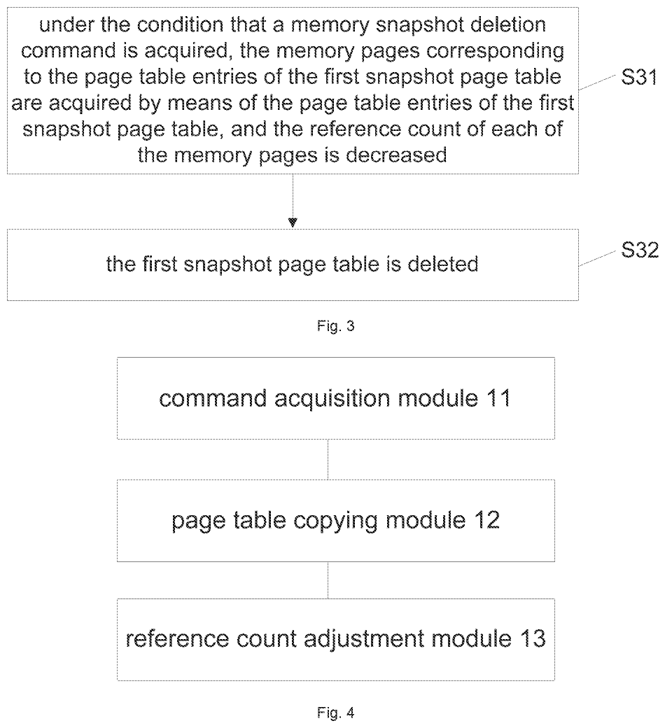

In a running process of the virtual machine, if a memory snapshot deletion command sent by a system administrator is received, that is, the first snapshot page table PT1 needs to be deleted, a operation of deleting a page table corresponding to the memory snapshot deletion command needs to be performed. Specifically, as shown in FIG. 3, the embodiment of the present disclosure may further include:
step S31: under the condition that a memory snapshot deletion command is acquired, the memory pages corresponding to the page table entries of the first snapshot page table are acquired by means of the page table entries of the first snapshot page table, and the reference count of each of the memory pages is decreased.

In this embodiment, after the memory snapshot deletion command sent by the system administrator is obtained, firstly, the corresponding memory pages are found by means of the page table entries of the first snapshot page table, and the reference count of each of the memory pages is decreased.

Step S32: the first snapshot page table is deleted.

In this embodiment, after the reference count is decreased, the first snapshot page table is directly deleted.

It may be determined that, in the embodiments of the present disclosure, when the memory snapshot deletion command is acquired, that is, when the first snapshot page table needs to be deleted, the corresponding memory pages are first found by means of the page table entries of the first snapshot page table, the reference count of each of the memory pages is decreased, and then the first snapshot page table is directly deleted. The snapshot page table is created by copying a page table, so that the speed of deleting a memory snapshot is also improved.

As shown in FIG. 4, an embodiment of the present disclosure discloses an apparatus for managing a memory snapshot, including:
a command acquisition module 11, configured to in the condition that a memory snapshot generation command is acquired, suspend a virtual machine:
a page table copying module 12, configured to copy a two-level page table of the virtual machine to obtain a first snapshot page table, and set a read-only identifier for each of page table entries of the two-level page table;
a reference count adjustment module 13, configured to acquire memory pages corresponding to page table entries of the first snapshot page table by means of the page table entries of the first snapshot page table, increase a reference count of each of the memory pages, and restore the virtual machine from a suspended state to a running state.

It may be determined that, in the embodiments of the present disclosure, when the memory snapshot generation command is acquired, the virtual machine is suspended; then the two-level page table of the virtual machine is copied to obtain the first snapshot page table, and the read-only identifier is set for each of page table entries of the two-level page table; and then the memory pages corresponding to the page table entries of the first snapshot page table is acquired by means of the page table entries of the first snapshot page table, the reference count of each of the memory pages is increased, and the virtual machine is restored from a suspended state to the running state. It may be determined therefrom that, in the present disclosure, after the memory snapshot generation command is acquired, the virtual machine needs to be suspended, the first snapshot page table is obtained by copying the two-level page table of the virtual machine so as to create a memory snapshot of the virtual machine, the read-only identifier is set for each of the page table entries of the two-level page table, and after the creation step is completed, the virtual machine is restored from the suspended state to the running state. The memory snapshot created by means of the described steps is still stored in the memory, and does not need to be written into a disk any more, thereby avoiding the impact of writing memory data into the disk on actual operations, and improving the speed of creating a memory snapshot. In addition, by setting the read-only identifier for the two-level page table of the virtual machine, differentiation between the memory snapshot and the virtual machine memory is implemented.

In some embodiments, after the reference count adjustment module 13, the apparatus further includes:
a memory write component, configured to in a running process of the virtual machine, under the condition of detecting that memory data in one memory page of the virtual machine is changed, perform a memory write operation.

In some embodiments, the memory write component may further include:
a page table query component, configured to exit the virtual machine from a virtual state, and query, by means of a virtual machine monitor program, the page table entries of the two-level page table, so as to obtain a query result;
a first copying component, configured to under the condition that the query result indicates that one page table entry carries the read-only identifier, copy a current memory page to obtain a copied memory page, and decrease the reference count of the memory page before the memory data is changed; and
an identifier clearing component, configured to point a pointer of the page table entry in the two-level page table to the copied memory page, clear the read-only identifier of the page table entry in the two-level page table, and re-enter the virtual machine into the virtual state.

In some embodiments, the apparatus for managing the memory snapshot may also include:
a second copying component, configured to under the condition that a memory snapshot restoration command is acquired, copy the first snapshot page table to obtain a second snapshot page table; and
a first page table deleting component, configured to delete a current two-level page table of the virtual machine, take the second snapshot page table as a new current two-level page table of the virtual machine, and clear page cache corresponding to the first snapshot page table.

In some embodiments, before the first page table deleting component, the apparatus further includes:
a reference count increasing component, configured to acquire the memory pages corresponding to the page table entries of the first snapshot page table by means of the page table entries of the first snapshot page table, and increase the reference count of each of the memory pages; and
a first reference count decreasing component, configured to acquire memory pages corresponding to page table entries of the current two-level page table by means of the page table entries of the current two-level page table, and decrease a reference count of each of the memory pages, and the memory pages corresponding to the page table entries of the first snapshot page table is the same as the memory pages corresponding to the page table entries of the current two-level page table.

In some embodiments, the apparatus for managing the memory snapshot may further include:
a second reference count decreasing component, configured to under the condition that a memory snapshot deletion command is acquired, acquire the memory pages corresponding to the page table entries of the first snapshot page table by means of the page table entries of the first snapshot page table, and decrease the reference count of each of the memory pages; and
a second page table deleting component, configured to delete the first snapshot page table.

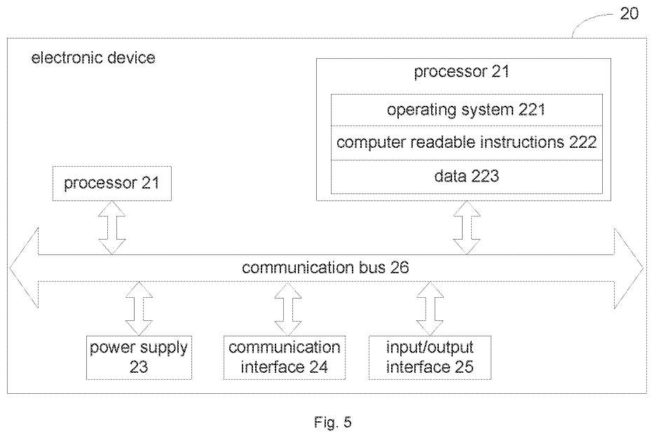

FIG. 5 is a structural schematic diagram of an electronic device according to an embodiment of the present disclosure. The electronic device may specifically include at least one processor 21, at least one memory 22, a power supply 23, a communication interface 24, an input/output interface 25, and a communication bus 26. The memory 22 is used for storing computer readable instructions, and the computer readable instructions are loaded and executed by the processor 21, so as to implement relevant steps in the method for managing the memory snapshot executed by the computer device and disclosed in any one of the described embodiments.

In this embodiment, the power supply 23 is used for providing an operating voltage for hardware devices in the computer device 20; the communication interface 24 may create a data transmission channel for the computer device 20 with an external device, and a communication protocol followed thereby is any communication protocol that may be applied to the technical solution of the present disclosure, and is not specifically limited herein; and the input/output interface 25 is used for acquiring external input data or outputting data the external world, and the specific interface type thereof may be selected according to specific disclosure requirements, and is not specifically limited herein.

The processor 21 may include one or more processing cores, for example, a 4-core processor and an 8-core processor. The processor 21 may be implemented in at least one hardware form of DSP (Digital Signal Processing), FPGA (Field-Programmable Gate Array), and PLA (Programmable Logic Array). The processor 21 may also include a main processor and a co-processor, and the main processor is a processor for processing data in an active state, also referred to as a CPU (Central Processing Component); and the co-processor is a low-power consumption processor for processing data in a standby state. In some embodiments, the processor 21 may be integrated with a GPU (Graphics Processing Component), and the GPU is responsible for rendering and drawing content required to be displayed on the display screen. In some embodiments, the processor 21 may further include an AI (Artificial Intelligence) processor, and the AI processor is used for processing computational operations related to machine learning.

In addition, the memory 22, as a carrier for resource storage, may be a read-only memory, a random access memory, a disk, an optical disk, or the like, and the resources stored thereon include an operating system 221, computer readable instructions 222, data 223, and the like, and the storage method may be either temporary storage or permanent storage.

The operating system 221 is used for managing and controlling hardware devices on the computer device 20 and the computer readable instructions 222, so as to implement computations and processing of the massive data 223 in the memory 22 by the processor 21, where the operating system 221 may be Windows, Unix, Linux, and the like. The computer readable instructions 222 may include, in addition to computer readable instructions that may be used to implement the method for managing a memory snapshot performed by the computer device 20 disclosed in any of the preceding embodiments, computer readable instructions that may be used to implement other specific tasks. The data 223 may include data received by the computer device and transmitted by an external device, and may also include data collected by the input/output interface 25 of the computer device.

Further, the embodiments of the present disclosure further disclose a storage medium. The storage medium stores computer readable instructions, and the computer readable instructions, when being loaded and executed by a processor, implement the method steps executed in a memory snapshot management process disclosed in any of the described embodiments.

The embodiments in this description are described in a progressive manner. Each embodiment focuses on a difference from other embodiments. For the same or similar parts among the embodiments, reference may be made to each other. As the apparatus disclosed in the embodiments corresponds to the method disclosed in the embodiments, the description thereof is relatively simple, and for the relevant parts, reference may be made to the description of the method.

A person skilled in the art may further appreciate that, in combination with the examples described in the embodiments disclosed in this description, components and algorithm steps may be implemented by electronic hardware, computer software, or a combination thereof. To clearly describe the interchangeability between the hardware and the software, the description has generally described compositions and steps of the examples according to functions. Whether the functions are executed by hardware or software depends on specific disclosures and design constraint conditions of the technical solutions. A person skilled in the art may use different methods to implement the described functions for each specific disclosure, but the implementation shall not be considered as going beyond the scope of the present disclosure.

The steps of a method or algorithm described in connection with the embodiments disclosed herein may be embodied directly in hardware, in a software module executed by a processor, or in a combination of the two. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

Finally, it should be noted that, in this description, terms such as first and second are merely used to distinguish one entity or operation from another entity or operation, and do not necessarily require or imply any actual relationship or sequence between these entities or operations. Furthermore, the terms “include”, “include”, or any other variant thereof are intended to cover a non-exclusive inclusion, so that a process, a method, an article, or a device that includes a series of elements not only includes those elements, but also includes other elements that are not explicitly listed, or further includes elements inherent to the process, the method, the article, or the device. If no more limitations are imposed, an element limited by “include a . . . ” does not exclude that another same element exists in a process, a method, an article, or a device that includes the foregoing element.

The foregoing describes in detail a memory and apparatus for managing a memory snapshot, a device, and a storage medium provided in the present disclosure. Specific examples are used in this description to describe the principle and implementations of the present disclosure. The foregoing descriptions of the embodiments are merely intended to help understand the method and core ideas of the present disclosure. In addition, a person skilled in the art may make modifications to the specific implementations and disclosure scopes according to the ideas of the present disclosure. In conclusion, the content of this description shall not be construed as a limitation to the present disclosure.

1. A method for managing a memory snapshot, comprising:
in response to acquiring a memory snapshot generation command, suspending a virtual machine;
copying a two-level page table of the virtual machine to obtain a first snapshot page table, and setting a read-only identifier for each of page table entries of the two-level page table; and
acquiring memory pages corresponding to page table entries of the first snapshot page table by means of the page table entries of the first snapshot page table, increasing a reference count of each of the memory pages, and restoring the virtual machine from a suspended state to a running state.

2. The method for managing the memory snapshot as claimed in claim 1, wherein copying the two-level page table of the virtual machine to obtain the first snapshot page table comprises:
copying the two-level page table of the virtual machine at a level of a Kernel-based Virtual Machine (KVM) to obtain the first snapshot page table, wherein the KVM is a virtualization technology.

3. The method for managing the memory snapshot as claimed in claim 1, the method further comprises:
after setting all of the page table entries of the two-level page table to a snapshot read-only mode, recording the two-level page table as an initial page table.

4. The method for managing the memory snapshot as claimed in claim 1, wherein the two-level page table, the first snapshot page table, and the memory pages are all stored in a memory.

5. The method for managing the memory snapshot as claimed in claim 1, wherein the method further comprises:
in response to the reference count of one memory page being decreased to zero, deleting a heap memory pointed to by an object.

6. The method for managing the memory snapshot as claimed in claim 1, wherein the method further comprises:
in response to increasing a reference to one memory page, increasing the reference count of the memory page by one, or in response to decreasing the reference to the memory page, decreasing the reference count of the memory page by one.

7. The method for managing the memory snapshot as claimed in claim 1, wherein after restoring the virtual machine from the suspended state to the running state, the method further comprises:
in a running process of the virtual machine, in response to detecting that memory data in one memory page of the virtual machine is changed, performing a memory write operation.

8. The method for managing the memory snapshot as claimed in claim 7, wherein in the process of performing the memory write operation, the method further comprises:
exiting the virtual machine from a virtual state, and querying, by means of a virtual machine monitor program, the page table entries of the two-level page table to obtain a query result;
in response to the query result indicating that one page table entry carries the read-only identifier, copying a current memory page to obtain a copied memory page, and decreasing the reference count of the memory page before the memory data is changed; and
pointing a pointer of the page table entry in the two-level page table to the copied memory page, clearing the read-only identifier of the page table entry in the two-level page table, and re-entering the virtual machine into the virtual state.

9. The method for managing the memory snapshot as claimed in claim 8, wherein the method further comprises:
setting the read-only identifier for the virtual machine; and
distinguishing a memory snapshot from a virtual machine memory according to the read-only identifier.

10. The method for managing the memory snapshot as claimed in claim 1, wherein the method further comprises:
in response to acquiring a memory snapshot restoration command, copying the first snapshot page table to obtain a second snapshot page table;
deleting a current two-level page table of the virtual machine, taking the second snapshot page table as a new current two-level page table of the virtual machine, and clearing page cache corresponding to the first snapshot page table.

11. The method for managing the memory snapshot as claimed in claim 10, wherein in response to acquiring the memory snapshot restoration command, copying the first snapshot page table to obtain the second snapshot page table comprises:
in response to acquiring the memory snapshot restoration command, acquiring an operation instruction transmitted from a level of a KVM; and
copying the first snapshot page table according to the operation instruction to obtain the second snapshot page table, wherein the KVM is a virtualization technology.

12. The method for managing the memory snapshot as claimed in claim 11, wherein before deleting the current two-level page table of the virtual machine, the method further comprises:
acquiring the memory pages corresponding to the page table entries of the first snapshot page table by means of the page table entries of the first snapshot page table, and increasing the reference count of each of the memory pages of the first snapshot page table;
acquiring memory pages corresponding to page table entries of the current two-level page table by means of the page table entries of the current two-level page table, and decreasing a reference count of each of the memory pages of the current two-level page table, wherein the memory pages corresponding to the page table entries of the first snapshot page table is the same as the memory pages corresponding to the page table entries of the current two-level page table.

13. (canceled)

14. The method for managing the memory snapshot as claimed in claim 12, wherein before acquiring the memory pages corresponding to the page table entries of the first snapshot page table by means of the page table entries of the first snapshot page table, the method further comprises.

15. The method for managing the memory snapshot as claimed in claim 1, wherein the method further comprises:
in response to acquiring a memory snapshot deletion command, acquiring the memory pages corresponding to the page table entries of the first snapshot page table by means of the page table entries of the first snapshot page table, and decreasing the reference count of each of the memory pages; and
deleting the first snapshot page table.

16. The method for managing the memory snapshot as claimed in claim 12, wherein after increasing the reference count of each of the memory pages and before restoring the virtual machine from the suspended state to the running state, the method further comprises:
clearing cache of the current two-level page table.

17. (canceled)

18. (canceled)

19. An electronic device, comprising:
one or more memories, configured to store computer readable instructions; and
one or more processors, configured to execute the computer readable instructions to cause the one or more processors to:
in response to acquiring a memory snapshot generation command, suspend a virtual machine;
copy a two-level page table of the virtual machine to obtain a first snapshot page table, and set a read-only identifier for each of page table entries of the two-level page table; and
acquire memory pages corresponding to page table entries of the first snapshot page table by means of the page table entries of the first snapshot page table, increase a reference count of each of the memory pages, and restore the virtual machine from a suspended state to a running state.

20. A non-volatile computer readable storage medium, configured to store computer readable instructions, wherein the computer readable instructions, when being executed by one or more processors, are configured to cause the one or more processors to:
in response to acquiring a memory snapshot generation command, suspend a virtual machine;
copy a two-level page table of the virtual machine to obtain a first snapshot page table, and set a read-only identifier for each of page table entries of the two-level page table; and
acquire memory pages corresponding to page table entries of the first snapshot page table by means of the page table entries of the first snapshot page table, increase a reference count of each of the memory pages, and restore the virtual machine from a suspended state to a running state.

21. The method for managing the memory snapshot as claimed in claim 1, wherein after restoring the virtual machine from the suspended state to the running state, the method further comprises:
in a running process of the virtual machine, in response to detecting that memory data in one memory page of the virtual machine is unchanged, not performing a memory write operation.

22. The method for managing the memory snapshot as claimed in claim 1, wherein the method further comprises:
after suspending a virtual machine, not copying all memory data.

23. The method for managing the memory snapshot as claimed in claim 1, wherein copying a two-level page table of the virtual machine to obtain a first snapshot page table comprises:
copying the two-level page table of the virtual machine to obtain the first snapshot page table, and using the first snapshot page table as a snapshot index.
